(19) United States
(12) Patent Application Publication
(10) Pub. No.: US 2026/0311940 A1
(43) Pub. Date: Oct. 8, 2026

(54) OPERATING MECHANISM AND ROTARY ISOLATING SWITCH

(71) Applicant: NOARK ELECTRICS(SHANGHAI) CO. LTD., Shanghai (CN)

(72) Inventors: Binbin GU, Shanghai (CN); Weijun GE, Shanghai (CN); Zhikai QIN, Shanghai (CN); Zhe GU, Shanghai (CN); Zhangqing ZHOU, Shanghai (CN)

(21) Appl. No.: 19/478,822

(22) PCT Filed: Apr. 7, 2024
(86) PCT No.: PCT/CN2024/086354

§ 371 Date: Oct. 26, 2025

(30) Foreign Application Priority Data
Apr. 27, 2023 (CN) 202310474683.3
Jul. 7, 2023 (CN) 202310832371.5
Oct. 17, 2023 (CN) 202311342330.4

(51) Int. Cl. H01H 3/46; H01H 19/14

(52) U.S. Cl. CPC H01H 3/46; H01H 19/14

(57) ABSTRACT

An operating mechanism and a rotary isolating switch that includes the operating mechanism. The operating mechanism includes a mechanism bracket, a link structure, a driving shaft structure and a rotating shaft and a transmission structure. The driving shaft structure is connected with the link structure through the transmission structure; the link structure is connected with the rotating shaft and drives the rotating shaft; the rotating shaft is connected with a support shaft for carrying a moving contact and drives the support shaft; the link structure includes a snap-fit structure. The operating mechanism includes a transmission rod; the rotating shaft and the support shaft are both arranged about an axis; both ends of the transmission rod are connected to the rotating shaft and the support shaft; and the transmission rod is located on a side of the axis and parallel to the axis.

The present application claims priority to Chinese Patent Application No. 202310474683.3 filed on Apr. 27, 2023, Chinese Patent Application No. 202310832371.5 filed on Jul. 7, 2023, and Chinese Patent Application No. 202311342330.4 filed on Oct. 17, 2023, all of which are incorporated herein in their entireties by reference.

### TECHNICAL FIELD

The present invention relates to the field of low-voltage electrical appliances, and more particularly, to an operating mechanism and a rotary isolating switch including the operating mechanism.

### BACKGROUND

In the existing rotary isolating switch, an operating mechanism is provided with a rotating shaft and a support shaft, wherein the support shaft is used to carry a moving contact, the rotating shaft is connected with the support shaft in a transmission manner through a transmission shaft pin, and the rotating shaft, the transmission shaft pin and the support shaft are arranged coaxially in a rotatable manner. The above connection mode increases the structural complexity of the rotating shaft and the support shaft, resulting in poor reliability and stability. In addition, due to insufficient creepage distance and insulating gap between the operating mechanism and a switch body, there is still a short circuit between the operating mechanism and the switch body, resulting in electric shock to an operator. Moreover, a transmission structure for the existing rotary isolating switch, which implements the transmission between a driving shaft structure and a rocker arm, has a complex structure and relatively low reliability. At present, the existing operating mechanism adopts a four-link & five-link switching structure, which includes a jump buckle, a lock buckle and a re-buckle which are rotatably arranged on a bracket, respectively. The jump buckle is in snap fit with the lock buckle, the lock buckle is in limiting fit with the re-buckle, and two spring arms of a return spring are fit with the lock buckle and the re-buckle, respectively. During assembly, the two spring arms of the return spring need to be fit with the lock buckle and the re-buckle respectively, and then the re-buckle is installed onto the bracket against the resistance of the return spring, resulting in high operation difficulty and low efficiency. In addition, in a case where the existing operating mechanism is in a tripped state, dead buckling is easily formed between the re-buckle and the lock buckle, resulting in the failure of re-buckling of the operating mechanism.

### SUMMARY

An object of the present invention is to overcome at least one defect of the prior art and provide an operating mechanism and a rotary isolating switch, which have simple structures and good reliability.

In order to achieve the above objective, the present invention provides the following technical solution:

an operating mechanism, includes a mechanism bracket, a link structure, a driving shaft structure and a rotating shaft which are rotatably arranged on the mechanism bracket, and a transmission structure, in which the driving shaft structure is connected with the link structure in a transmission manner through the transmission structure; the link structure is connected with the rotating shaft in a transmission manner and drives the rotating shaft to rotate reciprocatingly; the rotating shaft is connected with a support shaft for carrying a moving contact in a transmission manner and drives the support shaft to rotate reciprocatingly; the link structure comprises a snap-fit structure; the snap-fit structure has a snap-fit state and a tripped state; the operating mechanism further comprises a transmission rod; the rotating shaft and the support shaft are both arranged about an axis o-o; both ends of the transmission rod are connected to the rotating shaft and the support shaft; and the transmission rod is located on a side of the axis o-o and parallel to the axis 0-0.

Further, the mechanism bracket is provided with a transmission rod guide structure, and the transmission rod cooperates with the transmission rod guide structure to limit a swing trajectory of the transmission rod about the axis o-o.

Further, the mechanism bracket comprises an upper side plate and a lower side plate which are spaced apart from each other; the rotating shaft is rotatably arranged between the upper side plate and the lower side plate; the transmission rod guide structure comprises an upper guide structure arranged on the upper side plate and a lower guide structure arranged on the lower side plate; one end of the transmission rod passes through the rotating shaft and then cooperates with the upper guide structure, the other end of the transmission rod passes through the lower side plate and is then connected to the support shaft, and the transmission rod cooperates with the lower guide structure; and
the transmission rod comprises a transmission rod upper section, a transmission rod intermediate section and a transmission rod lower section which are sequentially connected in an axial direction; an outer diameter of the transmission rod intermediate section is greater than an outer diameter of the transmission rod upper section and an outer diameter of the transmission rod lower section; the transmission rod upper section is inserted into the rotating shaft, passes through the rotating shaft and then cooperates with the upper guide structure; the transmission rod intermediate section is located between the rotating shaft and the lower side plate, and is in limiting fit with the rotating shaft and the lower side plate to prevent the transmission rod from moving along the axial direction; and the transmission rod lower section passes through the lower side plate and is then connected to the support shaft.

Further, the operating mechanism further comprises a turntable which is fixedly connected to the support shaft and arranged between the transmission rod and the support shaft, and the rotating shaft is connected with the turntable in a transmission manner through the transmission rod to drive the support shaft to rotate; and the turntable is rotatably arranged about the axis o-o.

Further, the operating mechanism also includes a mechanism housing and a main body; the main body comprises a mechanism bracket, a link structure, a driving shaft structure, a rotating shaft and a transmission structure; the turntable is located on a side of the main body in an axial direction; the turntable comprises a turntable connecting hole and an anti-fool structure; one end of the transmission rod is a plug-in end for plug-in fit with the turntable connecting hole; and the anti-fool structure is used to abut against the plug-in end that is not inserted into the turntable connecting hole, preventing the main body from being installed in place.

Further, the operating mechanism further comprises a buffer part; and when the operating mechanism is opened, an output structure hits and docks on the buffer part, and the output structure comprises a rotating shaft and a transmission rod.

Further, the driving shaft structure comprises a driving shaft which is rotatably arranged on the mechanism bracket;
the link structure also comprises a rocker arm, wherein the rocker arm is rotatably arranged on the mechanism bracket, and the rocker arm is driven by an external force to swing reciprocatingly, so that the operating mechanism is closed and opened;
the transmission structure comprises a crank and a transmission link, wherein the crank is arranged on the driving shaft and rotates synchronously with the driving shaft, and the transmission link is connected with the crank and the rocker arm in a transmission manner;
the driving shaft is rotatably inserted into the rotating shaft about the axis o-o;
the rocker arm comprises a rocker arm beam, rocker arm legs and connecting toes, wherein two rocker arm legs are arranged to face each other and rotatably arranged on the mechanism bracket respectively, and one end of each of the two rocker arm legs is connected with the rocker arm beam in a bending manner;
the rocker arm beam and the connecting toes are located on both sides of a rotating axis of the rocker arm; and
the mechanism bracket comprises an upper side plate and a lower side plate which are spaced apart from each other; two rocker arm legs are located on both sides of the upper side plate and the lower side plate and rotatably arranged on the upper side plate and the lower side plate; each of the two rocker arm legs is provided with the connecting toe; and two groups of transmission structures are arranged on both sides of the upper side plate and the lower side plate; and the driving shaft is connected to the two connecting toes through the two groups of transmission structures.

Further, the rotating shaft comprises a rotating shaft main body, a rotating shaft connecting arm and a rotating shaft driving arm; the rotating shaft is rotatably arranged on the mechanism bracket through the rotating shaft main body; the rotating shaft connecting arm and the rotating shaft driving arm are arranged on both radial sides of the rotating shaft main body, and connected to the link structure and the transmission rod; or the rotating shaft comprises rotating shaft side plates and a rotating shaft connecting plate, wherein two rotating shaft side plates are spaced apart from each other and connected with the rotating shaft connecting plate in a bending manner, respectively; the middle of each of the two rotating shaft side plates rotates about the axis o-o; and both ends of each of the two rotating shaft side plates are connected with the link structure and the transmission rod in a transmission manner.

Further, the link structure comprises a re-buckle, a jump buckle, and a lock buckle which are rotatably arranged on the mechanism bracket respectively, and a return spring arranged between the lock buckle and the re-buckle; the jump buckle keeps snap fit with the lock buckle through the snap-fit structure; the re-buckle comprises a vertical arm and a transverse arm which are connected in a bending manner, and two spring arms of the return spring cooperate with the lock buckle and the vertical arm respectively; when the operating mechanism is normally opened and closed, the lock buckle keeps snap fit with the jump buckle and keeps first limiting fit with the transverse arm; the re-buckle is driven by an external force to rotate, the transverse arm releases first limiting fit from the lock buckle, the lock buckle and the jump buckle rotate respectively to release the snap fit, the operating mechanism is tripped, and the lock buckle establishes second limiting fit with the transverse arm; the vertical arm comprises a spring limiting groove arranged on a side thereof facing the lock buckle and an avoidance notch arranged on a side of the spring limiting groove; and the spring arm of the return spring that cooperates with the vertical arm is toggled and enters the spring limiting groove through the avoidance notch.

Further, one end of the vertical arm is connected with the transverse arm in a bending manner, and the spring limiting groove is formed in a side of the other end of the vertical arm that faces the lock buckle; and the bending connection between the vertical arm and the transverse arm is rotatably arranged on the mechanism bracket; and
the return spring makes the lock buckle and the re-buckle have a tendency to rotate in the same direction.

Further, the return spring is a torsion spring, which is arranged on the mechanism bracket or the lock buckle; and
the lock buckle comprises a lock buckle main body and a lock buckle supporting arm arranged on the lock buckle main body, wherein the lock buckle main body is in snap fit with the jump buckle; the return spring is arranged to sleeve the lock buckle supporting arm; and one spring arm cooperates with the lock buckle main body, and the other spring arm cooperates with the re-buckle.

Further, the re-buckle also comprises a limiting surface arranged on the transverse arm; the lock buckle comprises a lock buckle main body; the lock buckle is rotatably arranged on the mechanism bracket through the lock buckle main body; and when the operating mechanism is in a tripped state, the limiting surface abuts against one end of the lock buckle main body to prevent the re-buckle from resetting;
one end of the lock buckle main body is a lock buckle pivoting end and the other end of the lock buckle main body is a lock buckle mating end, and the lock buckle main body is rotatably arranged on the mechanism bracket through the lock buckle pivoting end; the lock buckle pivoting end is opposite to a free end of the vertical arm, the lock buckle mating end is opposite to the transverse arm, and the limiting surface is arranged on a side of the transverse arm facing the vertical arm; when the re-buckle establishes first limiting fit with the lock buckle, the transverse arm abuts against a side of the lock buckle mating end facing the re-buckle; when the re-buckle establishes second limiting fit with the lock buckle, the limiting surface abuts against the tip of the locking buckle mating end;
when the operating mechanism is in a tripped state, the limiting surface is in line or surface contact with one end of the lock buckle main body; and
an included angle between the center line of the vertical arm and the limiting surface is greater than 90°.

Further, when the operating mechanism is in a tripped state, the jump buckle abuts against the lock buckle to prevent the lock buckle from resetting.

Further, the link structure also comprises a rocker arm, a first link, a spring and a second link; the rocker arm is rotatably arranged on the mechanism bracket; the first link is rotatably connected to the jump buckle; the second link is rotatably connected to the first link and the rotating shaft; one end of the spring is connected to the rocker arm, and the other end of the spring is connected to the rotatable connection between the first link and the second link; the rocker arm is also used to drive the jump buckle to resume snap fit with the lock buckle; a stopper is arranged on the first link and used to be in limiting fit with the jump buckle to prevent the first link from continuing to rotate when the operating mechanism is opened or tripped; and
the mechanism bracket comprises an upper side plate and a lower side plate which are spaced apart from each other; the first link, the spring, the jump buckle, the lock buckle and the second link are all arranged between the upper side plate and the lower side plate; and a plane where the jump buckle, the lock buckle, the first link and the second link rotate is parallel to the upper side plate and the lower side plate and perpendicular to the rotating shaft.

A rotary isolating switch comprises the operating mechanism.

According to the operating mechanism of the present invention, a rotating shaft and a support shaft are connected in a transmission manner through a transmission rod, and the transmission rod is located on a side of a rotating axis of the rotating shaft and the support shaft. Compared with the prior art, the operating mechanism is conducive to simplifying the structures of the rotating shaft and the support shaft, improving the transmission reliability and rotation synchronization of the rotating shaft and the support shaft, and ensuring the action performance of the operating mechanism.

In addition, the transmission rod guide structure ensures the action reliability of the transmission rod, and further ensures the synchronization in the rotation of the rotating shaft and the support shaft.

In addition, the transmission structure includes a crank and a transmission link. Under the driving of the crank which is rotatably arranged on a driving shaft and synchronously rotates along with this driving shaft, the driving shaft structure and a physical structure of a link structure are connected, achieving a simple structure and transmission reliability.

In addition, a mode of the rotating shaft+transmission rod+turntable drives the rotation of the moving contact mechanism, which is conducive to increasing a creepage distance and insulating gap between the operating mechanism and the switch body, ensuring the personal safety of an operator, and avoiding the occurrence of electric shock accidents caused by a short circuit between the operating mechanism and the switch body.

In addition, the transmission structure is arranged symmetrically, which improves the stability and reliability of the transmission of the driving structure and the rocker arm.

In addition, when the operating mechanism of the present invention is assembled, the structural design of an avoidance notch of the re-buckle and a spring limiting groove enables the operating mechanism to first complete the assembly of the lock buckle, the re-buckle, the return spring and the spring shaft, and the mechanism bracket in the assembly process. After an upper side plate and a lower side plate of the mechanism bracket are fixed to each other (for example, the upper side plate and the lower side plate are fixedly connected together by a connecting shaft), the assembly between the return spring and the re-buckle is completed, thereby simplifying the assembly operation, reducing the assembly difficulty of the return spring, and improving the assembly efficiency.

In addition, an included angle a between a center line of a vertical arm of the re-buckle and a limiting surface is greater than 90°, so as to ensure that when the operating mechanism is re-buckled, the lock buckle can be smoothly separated from the limiting surface and reset, thereby avoid the failure of the operating mechanism caused by dead buckling of the re-buckle and the lock buckle.

In addition, after the operating mechanism is tripped, the lock buckle and the jump buckle abut against each other to prevent the lock buckle from resetting, thereby avoiding dead buckling when the lock buckle resumes snap with the jump buckle.

In addition, the buffer part is made of a flexible material, such as plastic or rubber, and plays a buffering role in the operating mechanism to ensure that the operating mechanism will not trip and disintegrate due to hard impact during the opening process.

A rotary isolating switch of the present invention includes the operating mechanism and has a simple structure and good reliability.

### BRIEF DESCRIPTION OF THE DRAWINGS

FIG. 1 is a schematic sectional view of a rotary isolating switch of the present invention;

FIG. 2 is a schematic exploded view of the rotary isolating switch of the present invention;

FIG. 3 is a schematic diagram of a projection of an operating mechanism in an opened state in the present invention;

FIG. 4 is a schematic sectional view of the operating mechanism in an opened state in the present invention;

FIG. 5 is a schematic diagram of a projection of the operating mechanism in a closed state in the present invention;

FIG. 6 is a schematic sectional view of the operating mechanism in a closed state in the present invention;

FIG. 7 is a schematic structural diagram of a rocker arm in the present invention;

FIG. 8 is a schematic structural diagram of a transmission rod in the present invention;

FIG. 9 is a schematic sectional view of a support shaft in the present invention;

FIG. 10 is a schematic exploded view of a rotary isolating switch of the present invention, in which a transmission rod of an operating mechanism is connected with a contact support in a transmission manner through a turntable;

FIG. 11 is a schematic sectional view of the rotary isolating switch of the present invention, in which a cooperative relationship of the transmission rod and a buffer part is shown at least;

FIG. 12 is a schematic structural diagram of a turntable in the present invention;

FIG. 13 is a schematic sectional view of the turntable and the contact support in the present invention;

FIG. 14 is a schematic structural diagram of the operating mechanism in an opened state in the present invention, in which a cooperative relationship between the transmission rod and the buffer part is shown at least;

FIG. 15 is a schematic structural diagram of the operating mechanism of the present invention, in which a return spring is in an unassembled state, and a second arm of the return spring has not yet been assembled in place;

FIG. 16 is a schematic structural diagram of the operating mechanism of the present invention, in which the return spring is installed in place, and a lock buckle releases snap fit from a jump buckle and establishes second limiting fit with a re-buckle;

FIG. 17 is a projection view of the operating mechanism of the present invention, in which the lock buckle releases snap fit from the jump buckle and establishes second limiting fit with the re-buckle;

FIG. 18 is a schematic structural diagram of the re-buckle in the present invention from one perspective;

FIG. 19 is a schematic structural diagram of the re-buckle in the present invention from another perspective;

FIG. 20 is a schematic structural diagram of the operating mechanism of the present invention, in which the return spring is arranged to sleeve a spring supporting arm of the lock buckle;

FIG. 21 is a schematic structural diagram of the lock buckle of the operating mechanism shown in FIG. 20 of the present invention; and

FIG. 22 is another schematic structural diagram of a turntable in the present invention.

Reference symbols represent the following components:
h—mechanism housing; 0—mechanism bracket; 6—upper side plate; 6-0—upper guide structure; 7—lower side plate; 7-0—lower guide structure;
1—transmission rod; 1-0—transmission rod upper section; 1-1—transmission rod intermediate section; 1-2—transmission rod lower section;
2—driving shaft; 2-0—driving shaft upper section; 2-1—driving shaft intermediate section; 2-2—driving shaft lower section;
5—rocker arm; 5-0—rocker arm beam; 5-1—rocker arm leg; 5-10—rocker arm shaft hole; 5-2—connecting toe;
8—first link;
9—spring;
10—support shaft; 10-0—support connecting hole; 10-1—pillow block;
11—rotating shaft; 11-0—rotating shaft connecting arm; 11-1—rotating shaft main body; 11-2—rotating shaft driving arm; 11a—rotating shaft side plate; 11b—rotating shaft connecting plate;
12—jump buckle;
13—lock buckle; 13-0—lock buckle main body; 13-00—lock buckle main plate; 13-01—lock buckle side plate; 13-1—lock buckle long arm; 13-2—lock buckle supporting finger; 13-3—spring supporting arm;
14—re—buckle; 14-0—vertical arm; 14-00—avoidance notch; 14-01—spring limiting groove; 14-02—vertical arm main plate; 14-03—vertical arm side plate; 14-04—vertical arm stiffener; 14-1—transverse arm; 14-10—limiting boss; 14-100—limiting surface; 14-2—stroke limiting shaft;
15—second link;
16—stopper;
17—return spring;
18—jump buckle stopping shaft;
19—auxiliary spring;
27—return spring; 27-1—first arm 1; 27-2—second arm;
34—transmission structure; 3—crank; 4—transmission link;
30—body housing; 30-0—housing shaft hole;
40—contact support; 40-101—main plug; 40-100—auxiliary plug;
41—buffer part;
60—rotating shaft; 60-1—turntable connecting hole; 60-10—reinforced enclosure; 60-2—turntable pillow block; 60-3—turntable main plate; 60-5—primary jack; 60-6—secondary jack; 60m—turntable main plate; 60-1p—first table; 60-2p—second table; 60-3p—third table; and
1s—first shaft; 2s—second shaft; 3s—third shaft; 4s—fourth shaft; 5s—fifth shaft; 6s—sixth shaft; 7s—seventh shaft; 8s—eighth shaft; and 9s—ninth shaft.

### DETAILED DESCRIPTION

The specific implementations of a rotary isolating switch of the present invention will be further described below in conjunction with the embodiments given in the accompanying drawings. The rotary isolating switch of the present invention is not limited to the description of the following embodiments.

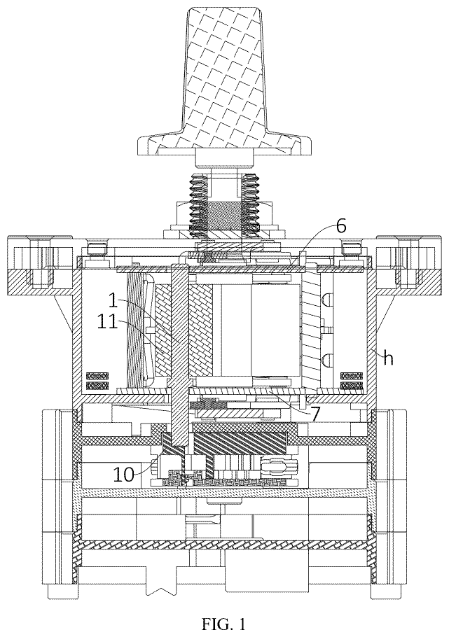

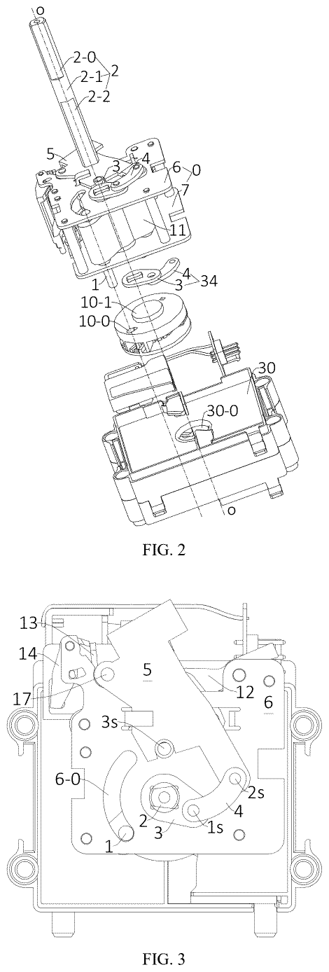

An embodiment of a rotary isolating switch of the present invention is shown in FIGS. 1-2.

The rotary isolating switch in the present embodiment includes an operating mechanism and a switch body. The switch body includes a support shaft 10 which is arranged rotatably and at least one group of contact systems. The contact system includes a moving contact and a static contact which are used cooperatively. The support shaft 10 is used to carry the moving contact, that is, the moving contact is installed on the support shaft 10. The operating mechanism is connected with the support shaft 10 in a transmission manner and drives the moving contact and the static contact to be closed and disconnected, that is, the rotary isolating switch is closed and opened. Further, the switch body includes two or more groups of contact systems. The contact systems are stacked up and down. The operating mechanisms are stacked on the uppermost contact system. The moving contacts of the contact systems are all arranged on the support shaft 10. The support shaft 10 is connected with the operating mechanisms in a driving manner. The operating mechanisms drive the moving contacts to rotate synchronously through the support shaft 10 and to be closed with and disconnected from the corresponding static contacts respectively. Referring to FIGS. 1-2, the operating mechanism includes a knob. The knob rotates under an external force to drive the operating mechanism to act, and then to drive the rotating shaft 11 of the operating mechanism to rotate. Meanwhile, the rotating shaft 11 drives the support shaft 10 to rotate, achieving the synchronous rotation of the moving contacts.

As shown in FIGS. 1-8, the operating mechanism includes a mechanism bracket 0, a link structure, a driving shaft structure and a rotating shaft 11 which are rotatably arranged on the mechanism bracket 0 respectively, and a transmission structure 34. The driving shaft structure in the present embodiment includes a knob. The driving shaft structure is connected with the link structure in a transmission manner through the transmission structure 34. The link structure is connected with the rotating shaft 11 in a transmission manner and drives the rotating shaft 11 to rotate reciprocatingly. The rotating shaft 11 is connected with the support shaft 10 for carrying the moving contact in a transmission manner and drives the support shaft 10 to rotate reciprocatingly. The link structure includes a snap-fit structure. The snap-fit structure has a snap-fit state and a tripped state. The operating mechanism further includes a transmission rod 1. The rotating shaft 11 and the support shaft 10 are both rotatably arranged about an axis o-o. Both ends of the transmission rod 1 are connected to the rotating shaft 11 and the support shaft 10. The transmission rod 1 is located on a side of the axis o-o and parallel to the axis o-o. According to the operating mechanism, the rotating shaft 11 and the support shaft 10 are connected in a transmission manner through the transmission rod 1, and the transmission rod 1 is located on a side of a rotating axis of the rotating shaft 11 and the support shaft 10. Compared with the prior art, the operating mechanism is conducive to simplifying the structures of the rotating shaft 11 and the support shaft 10, improving the transmission reliability and rotation synchronization of the rotating shaft 11 and the support shaft 10, and ensuring the action performance of the operating mechanism.

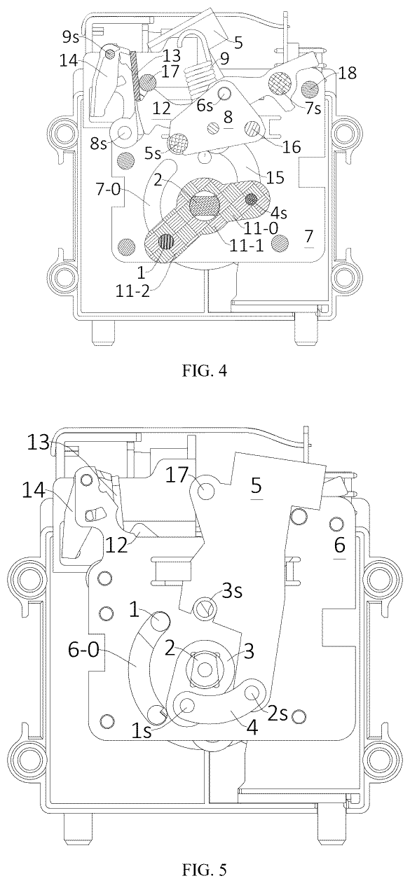

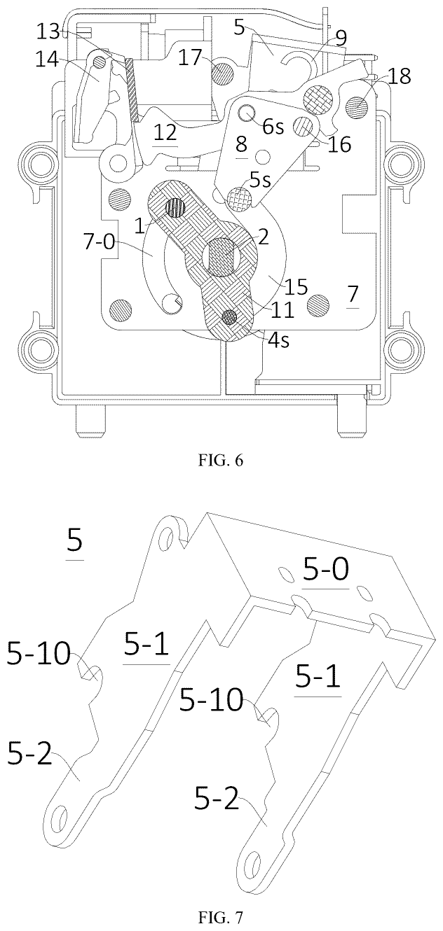

As shown in FIGS. 1-6, the operating mechanism can be implemented by a four-link & five-link switching scheme in the prior art. Specifically, the link structure includes a rocker arm 5, a first link 8, a spring 9, a jump buckle 12, a lock buckle 13, a second link 15 and a stopper 16. The rocker arm 5, the jump buckle 12 and the lock buckle 13 are rotatably arranged on the mechanism bracket 0, respectively. The jump buckle 12 is in snap fit with the lock buckle 13 through a snap-fit structure. The first link 8 is rotatably connected to the jump buckle 12. The second link 15 is rotatably connected to the first link 8 and the rotating shaft 11. One end of the spring 9 is connected to the rocker arm 5, and the other end of the spring 9 is connected to the rotatable connection between the first link 8 and the second link 15 (specifically, as shown in FIG. 4 and FIG. 6, the first link 8 and the second link 15 are rotatably connected through a fifth shaft 5s, and this end of the spring 9 is connected to the fifth shaft 5s). The jump buckle 12 is in snap fit with the lock buckle 13, i.e., in a snap-fit state. At this time, the link structure can drive the rotating shaft 11 to rotate, and then drive the support shaft 10 to rotate to achieve closing and opening. The jump buckle 12 releases snap fit from the lock buckle 12, i.e., in a tripped state. When the rotary isolating switch is in the closed state, the jump buckle 12 is tripped to release snap fit from the lock buckle 13, i.e., in a tripped state. At this time, four-link & five-link of the operating mechanism disintegrates, the rotating shaft 11 is driven by the spring 9 to rotate in a reverse direction, and then the support shaft 10 is driven to rotate to achieve tripping and opening.

The rocker arm 5 is also used to drive the jump buckle 12 to resume snap fit with the lock buckle 13. After the jump buckle 12 releases snap fit from the lock buckle 13, the rocker arm 5 swings to drive the jump buckle 12 to rotate and resume snap fit with the lock buckle 13. The stopper 16 is arranged on the first link 8 and used to be in limiting fit with the jump buckle 12 to prevent the first link 8 from continuing to rotate when the operating mechanism is opened or tripped. Further, the link structure also includes a re-buckle 14 which is rotatably arranged on the mechanism bracket 0, and a reset shaft 17 arranged on the rocker arm 5. The rocker arm 5 drives the jump buckle 12 to resume snap fit with the lock buckle 13 through the reset shaft 17. That is, the rocker arm 5 drives the reset shaft 17 to act synchronously, so that the reset shaft 17 abuts against the jump buckle 12, the jump buckle 12 rotates to resume snap fit with the lock buckle 13, and the re-buckle 14 is in limiting fit with the lock buckle 13. The re-buckle 14 is driven by an external force (e.g., the re-buckle 14 is driven by a driving force form an overload protection mechanism, a short-circuit protection mechanism or a magnetic flux tripper, wherein the overload protection mechanism and the short-circuit protection mechanism may be arranged independently of each other or as an integrated mechanism) to rotate, and releases limiting fit from the lock buckle 13, and the lock buckle 13 rotates to release snap fit from the jump buckle 12. Further, the operating mechanism further includes a jump buckle stop shaft 18. When the operating mechanism trips, the jump buckle 12 cooperates with the jump buckle stop shaft 18 to prevent the jump buckle 12 from continuing to rotate. As shown in FIGS. 1-6, the mechanism bracket 0 includes an upper side plate 6 and a lower side plate 7 which are spaced apart from each other.

As shown in FIGS. 1-2, the rotating shaft 11 is rotatably arranged between the upper side plate 6 and the lower side plate 7, and the rotating shaft 11 is perpendicular to the upper side plate 6 and the lower side plate 7.

As shown in FIGS. 1-6, the first link 8, the spring 9, the jump buckle 12, the lock buckle 13, the second link 15 and the stopper 16 are all arranged between the upper side plate 6 and the lower side plate 7. A plane where the jump buckle 12, the lock buckle 13, the first link 8 and the second link 15 rotate is parallel to the upper side plate 6 and the lower side plate 7 and perpendicular to the rotating shaft 11.

As shown in FIG. 4 and FIG. 6, one end of the jump buckle 12 is rotatably arranged on the upper side plate 6 and the lower side plate 7 through a seventh shaft 7s, and the other end of the jump buckle 12 is in snap fit with the lock buckle 13 through the snap-fit structure. The lock buckle 13 is rotatably arranged on the upper side plate 6 and the lower side plate 7 through an eighth shaft 8s. The re-buckle 14 is rotatably arranged on the upper side plate 6 and the lower side plate 7 through a ninth shaft 9s. The first link 8 is rotatably connected to the middle of the jump buckle 12 through a sixth shaft 6s. The first link 8 is hinged with one end of the second link 15 through a fifth shaft 5s. The other end of the second link 15 is hinged with the rotating shaft 11 through a fourth shaft 4s.

As shown in FIGS. 2-6, the rocker arm 5 is driven by an external force to swing reciprocatingly, so that the operating mechanism is closed and opened. Further, the rocker arm 5 includes a rocker arm beam 5-0 and rocker arm legs 5-1. Two rocker arm legs 5-1 are spaced apart from each other. One end of each rocker arm leg 5-1 is connected with the rocker arm beam 5-0 in a bending manner. The two rocker arm legs 5-1 are rotatably arranged on the upper side plate 6 and the lower side plate 7, respectively. The rocker arm legs 5-1 are parallel to the upper side plate 6 and the lower side plate 7 and perpendicular to the rotating shaft 11. Further, the two rocker arm legs 5-1 are arranged on both sides of the upper side plate 6 and the lower side plate 7. Further, a rotating axis of the rocker arm 5 is spaced in parallel from the axis o-o. Further, the two rocker arm legs 5-1 are rotatably arranged on the upper side plate 6 and the lower side plate 7 through two groups of third shafts 3s, respectively.

As shown in FIGS. 1-6, the mechanism bracket 0 is provided with a transmission rod guide structure. The transmission rod 1 cooperates with the transmission rod guide structure to limit a swing trajectory of the transmission rod 1 about the axis o-o, thereby ensuring the action reliability of the transmission rod 1 and further ensuring the synchronization in the rotation of the rotating shaft 11 and the support shaft 10. Further, the transmission rod guide structure includes an upper guide structure 6-0 arranged on the upper side plate 6 and a lower guide structure 7-0 arranged on the lower side plate 7. One end of the transmission rod 1 passes through the rotating shaft 11 and then cooperates with the upper guide structure 6-0, the other end of the transmission rod 1 passes through the lower side plate 7 and is then connected to the support shaft 10, and the transmission rod 1 also cooperates with the lower guide structure 7-0. Further, the upper guide structure 6-0 is an arc-shaped hole formed in the upper side plate 6, and the lower guide structure 7-0 is an arc-shaped hole formed in the lower side plate 7. One end of the transmission rod 1 passes through the rotating shaft 11 and is then inserted into the upper guide structure 6-0, and the other end of the transmission rod 1 passes through the lower side plate 7 and is then connected to the support shaft 10. That is, the transmission rod 1 is inserted into the rotating shaft 11, and parts of the transmission rod 1 that protrude out of both sides of the rotating shaft 11 are inserted into the two arc-shaped holes. Further, the two arc-shaped holes of the upper guide structure 6-0 and the lower guide structure 7-0 are adapted to a movement trajectory of the transmission rod 1. The transmission rod guide structure has a simple structure, is simply assembled with the transmission rod 1, and reliably limits the movement trajectory of the transmission rod 1. Of course, the transmission rod guide structure is not limited to the above two implementation ways. For example, the upper guide structure 6-0 may also be an arc-shaped groove formed in the upper side plate 6, and the lower guide structure 7-0 is two arc-shaped ribs which are spaced on the lower side plate. A person skilled in the art may also make other deformations, which will not be listed here, and various deformations should all fall within the protection scope of the transmission rod guide structure in the present application.

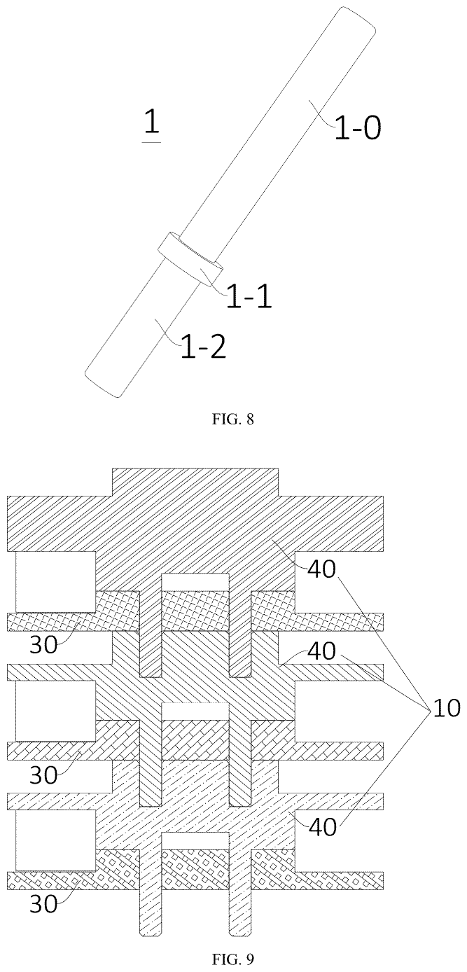

Specifically, as shown in FIG. 8, the transmission rod 1 includes a transmission rod upper section 1-0, a transmission rod intermediate section 1-1 and a transmission rod lower section 1-2 which are sequentially connected in an axial direction. An outer diameter of the transmission rod intermediate section 1-1 is greater than an outer diameter of the transmission rod upper section 1-0 and an outer diameter of the transmission rod lower section 1-2. The transmission rod upper section 1-0 is inserted into the rotating shaft 11, passes through the rotating shaft 11 and cooperates with the upper guide structure 6-0. The transmission rod intermediate section 1-1 is located between the rotating shaft 11 and the lower side plate 7, and is in limiting fit with the rotating shaft 11 and the lower side plate 7 to prevent the transmission rod 1 from moving along the axial direction. That is, an upper step surface is formed at the connection between the transmission rod upper section 1-0 and the transmission rod intermediate section 101, and a lower step surface is formed at the connection between the transmission rod intermediate section 1-1 and the transmission rod lower section 1-2. The upper step surface abuts against the rotating shaft 11, and the lower step surface abuts against the lower side plate 7, so as to avoid instable transmission or transmission failure of the rotating shaft 11 and the support shaft 10 caused by the deviation of the transmission rod 11 from a working position, and to ensure the reliable and stable working of the operating mechanism.

As shown in FIGS. 1-2, and 9, the support shaft 10 includes at least one contact support 40 which is sequentially arranged along the axis o-o. In the present embodiment, the support shaft 10 includes a plurality of contact supports 40 which are sequentially arranged along the axis o-o, and the contact supports 40 rotate synchronously to form the support shaft 10. The transmission rod 1 is connected with one contact support 40 close to the rotating shaft 11 in a transmission manner. Each contact support 40 is provided with moving contacts of a group of contact systems. The moving contacts penetrate through the contact supports 40. Both ends of each moving contact cooperate with two static contacts. Further, the support shaft 10 also includes a support connecting hole 10-0. The support connecting hole 10-0 is formed in a side of the axis o-o along a radial direction of the support shaft 10. The transmission rod 1 is inserted into the support connecting hole 10-0. Further, in the support shaft 10, at least one contact support 10 close to the rotating shaft 11 is provided with the support connecting hole 10-0. Specifically, the switch body includes at least one group of switch units. Each switch unit includes a contact system. The contact system includes a moving contact mechanism which is arranged rotatably, and a static contact cooperating with the moving contact mechanism. The operating mechanism is connected with the moving contact mechanism of each switch unit in a transmission manner. Each moving contact mechanism is driven to rotate so as to be closed with and disconnected from the corresponding static contact, so that the isolating switch is closed and opened. Further, the moving contact mechanism includes a contact support 40 which is arranged rotatably, and each contact support 40 is connected with the operating mechanism in a transmission manner. Further, the operating mechanism and the switch body are stacked along the rotating axis of the moving contact mechanism. Further, the switch body includes two or more groups of switch units. The switch units are stacked along the rotating axis of the moving contact mechanism. The contact systems of the switch units are closed and disconnected synchronously.

Further, the adjacent contact supports 40 are connected in a transmission manner through transmission shaft pins. The transmission shaft pins are in plug-in fit with the corresponding two contact supports 40, so as to implement the synchronous rotation of the contact supports 40. A rotating axis of the transmission shaft pin coincides with the axis o-o.

As other embodiments, as shown in FIG. 2 and FIG. 9, one of two pillow blocks 10-1 between the two adjacent contact supports 40 is provided with a transmission protrusion, and the other pillow block 10-1 is provided with a transmission groove. The transmission protrusion is inserted into the transmission groove and is in limiting fit with the transmission groove, thereby achieving the synchronous rotation of a plurality of contact supports 40.

As other embodiments, the contact supports 40 of the support shaft 1 are of an integral structure.

As other embodiments, the transmission rod 1 passes through the contact supports 40 in sequence, thereby achieving the synchronous rotation of the contact supports 40.

As shown in FIG. 4 and FIG. 6, the rotating shaft 11 includes a rotating shaft main body 11-1, a rotating shaft connecting arm 11-0 and a rotating shaft driving arm 11-2. The rotating shaft 11 is rotatably arranged on the mechanism bracket 0 through the rotating shaft main body 11-1. The rotating shaft connecting arm 11-0 and the rotating shaft driving arm 11-2 are arranged on both radial sides of the rotating shaft main body 11-1, and connected to the link structure and the transmission rod 1. Further, the transmission rod 1 is inserted into the rotating shaft driving arm 11-2, and the rotating shaft connecting arm 11-0 is rotatably connected to the second link 15. Further, an included angle between the rotating shaft connecting arm 11-0 and the rotating shaft driving arm 11-2 is an obtuse angle.

FIGS. 2-3, 5, and 7 show an implementation way in which the driving shaft structure, the transmission structure and the link structure are connected in a transmission manner: the driving shaft structure includes a driving shaft 2 which is rotatably arranged on the mechanism bracket 0. Further, the driving shaft structure also includes a knob for operation by an external force. The knob is arranged at one end of the driving shaft 2 and rotates synchronously with the driving shaft 2. The transmission structure includes a crank 3 and a transmission link 4. The crank 3 is arranged on the driving shaft 2 and rotates synchronously with the driving shaft 2. The transmission link 4 is connected with the crank 3 and the rocker arm 5 in a transmission manner, respectively. The driving shaft structure and a physical structure of the link structure are connected by the transmission structure 34, achieving a simple structure and reliable transmission. Further, the crank 3 is hinged with one end of the transmission link 4 through a first shaft 1s, and the other end of the transmission link 4 is hinged with a connecting toe 5-2 of the rocker arm 5 through a second shaft 2s.

As shown in FIGS. 1-2, the driving shaft structure is rotatably arranged about the axis o-o. Further, the driving shaft 2 is rotatably arranged about the axis o-o. That is, the driving shaft 2, the rotating shaft 11 and the support shaft 10 are arranged coaxially in a rotatable manner.

Further, the rocker arm 5 of the link structure also includes connecting toes 5-2. At least one rocker arm leg 5-1 of the rocker arm 5 is provided with the connecting toe 5-2, and connected to the transmission link 4 through the connecting toe 5-2. Further, the rocker arm beam 5-0, and the connecting toes 5-2 are located on both sides of the rotating axis of the rocker arm 5. That is, in a plane perpendicular to the rotating axis of the rocker arm 5, the rotating axis of the rocker arm 5 is located between the rocker arm beam 5-0 and the connecting toe 5-2 and is located on a side of a connecting line between the rocker arm beam 5-0 and the connecting toe 5-2. Further, the rocker arm leg 5-1 and the connecting toe 5-2 are coplanar. One end of the rocker arm leg 5-1 is connected with the rocker arm beam 5-0 in a bending manner, and the connecting toe 5-2 is arranged at the other end of the rocker arm leg 5-1. A supporting shoulder is formed at a side of the connection between the connecting toe 5-2 and the rocker arm leg 5-1, and the rocker arm leg 5-1 is rotatably arranged on the mechanism bracket 0 through the supporting shoulder. Further, the supporting shoulder is provided with a rocker arm shaft hole 5-10. The supporting shoulder is rotatably arranged on a third shaft 3s through the rocker arm shaft hole 5-10, and the third shaft 3s is fixed on the mechanism bracket 0.

Further, the crank 3 includes a crank connecting hole. A sidewall of the crank connecting hole is provided with a crank limiting surface. The driving shaft 2 includes a driving shaft limiting surface arranged thereon. The driving shaft 2 is inserted into the crank connecting hole. The crank limiting surface is in limiting fit with the driving shaft limiting surface, such that the crank 3 rotate synchronously with the driving shaft 2. The connection structure of the driving shaft 2 and the crank 3 is simple and reliable, and ensures the reliability and stability of the transmission between the driving shaft structure and the transmission structure.

Specifically, as shown in FIGS. 2-3, 5 and 7, each of the two rocker arm legs 5-1 of the rocker arm 5 is provided with the connecting toe 5-2. Two groups of transmission structures are arranged on both sides of the upper side plate 6 and the lower side plate 7 of the mechanism bracket 0. The driving shaft 2 is connected to the two connecting toes 5-2 through the two groups of transmission structures 34. The transmission structures 34 are arranged symmetrically, which improves the stability and reliability of the transmission of the driving shaft structure and the rocker arm 5. Further, the driving shaft 2 includes a driving shaft upper section 2-0, a driving shaft intermediate section 2-1 and a driving shaft lower section 2-2 which are sequentially connected in an axial direction. The driving shaft upper section 2-0 and the driving shaft lower section 2-2 are provided with a driving shaft limiting surface, respectively. The two groups of driving shaft limiting surfaces are in limiting fit with crank limiting surfaces of the two groups of cranks 3.

The operating mechanism of the present embodiment achieves a structure in which the knob drives the support shaft 10 through four-link & five-link. The main body structure of the operating mechanism is a vertically stacked structure. The main body structure is located between the upper side plate 6 and the lower side plate 7, achieving compact overall structure and small occupied space.

As shown in FIGS. 1-2, the switch body further includes a body housing 30 in which the support shaft 10 and the contact system are arranged. The body housing 30 in the present embodiment includes a plurality of contact cavities which are sequentially spaced. One contact support 40 of the support shaft 10 and a group of contact systems are arranged in each contact cavity. The moving contacts of each group of contact systems are arranged on the corresponding contact support 40. The contact support 40 includes two pillow blocks 10-1 at both axial ends. A pair of sidewalls of each contact cavity are provided with a housing shaft hole 30-0, respectively. The two pillow blocks 10-1 of the contact support 40 are rotatably arranged in the corresponding two housing shaft holes 30-0, respectively. Further, each contact system includes a moving contact and two static contacts used in conjunction with the moving contact. The two static contacts are symmetrically arranged on both sides of the contact support 40. The moving contact penetrates through the corresponding contact support 40. Both ends of the moving contact cooperate with the two static contacts. The assembly structure of the support shaft 10 and the body housing 30 is simple and reliable, ensures the reliable and stable rotation of the support shaft 10 in a working position, and also ensures the opening and closing performances of the rotary isolating switch.

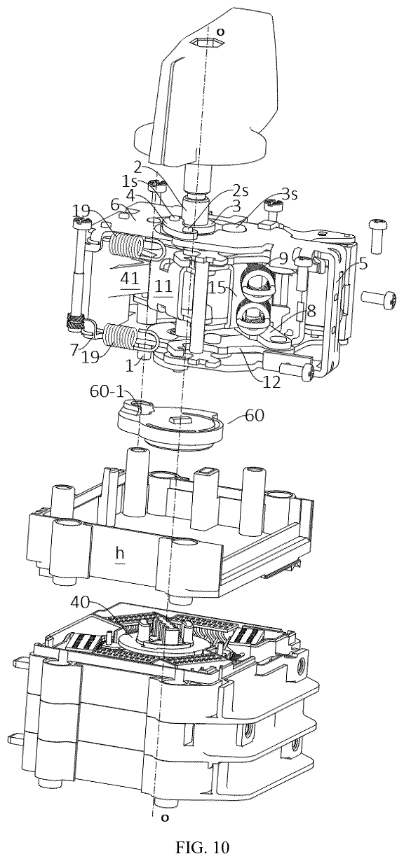

Another embodiment of a rotary isolating switch of the present invention is shown in FIGS. 10-22. The rotary isolating switch of the present embodiment differs from that of the previous embodiment in that:

as shown in FIGS. 10-11, the operating mechanism further includes a turntable 60 which is fixedly connected to the support shaft 10 and arranged between the transmission rod 1 and the support shaft 10, and the rotating shaft 11 is connected with the turntable 60 in a transmission manner through the transmission rod 1 to drive the support shaft 10 to rotate. The turntable 60 is rotatably arranged about the axis o-o. A mode of the rotating shaft 11+transmission rod 1+turntable 60 drives the moving contact mechanism to rotate, which is conducive to increasing a creepage distance and insulating gap between the operating mechanism and the switch body, ensuring the personal safety of an operator, and avoiding the occurrence of electric shock accidents caused by a short circuit between the operating mechanism and the switch body. Further, the turntable 60 is arranged outside one side plate of the mechanism bracket 0, and one end of the transmission rod 1 passes through this side plate and is then connected with the turntable 60 in a transmission manner. This side plate is preferably the lower side plate 7 of the mechanism bracket 0 (that is, the side plate close to the switch body). Further, the turntable 60 and the transmission rod 1 are arranged in a mechanism housing h.

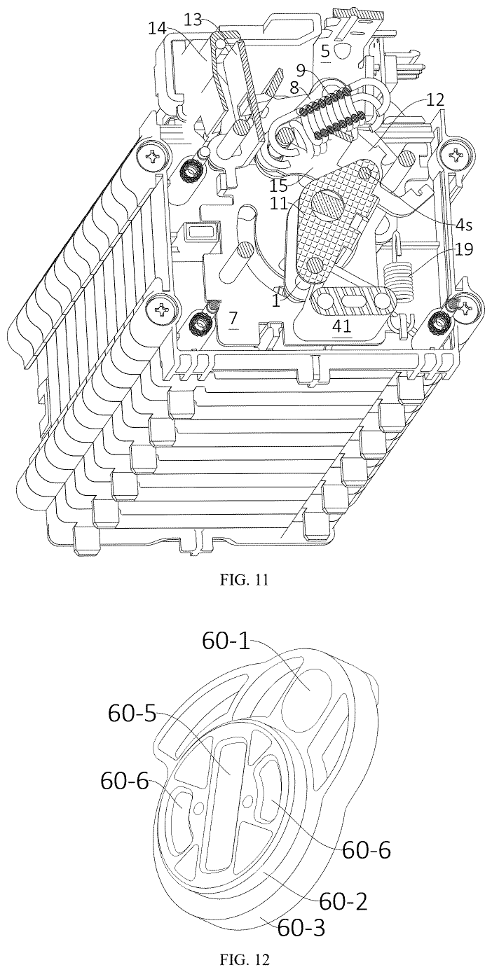

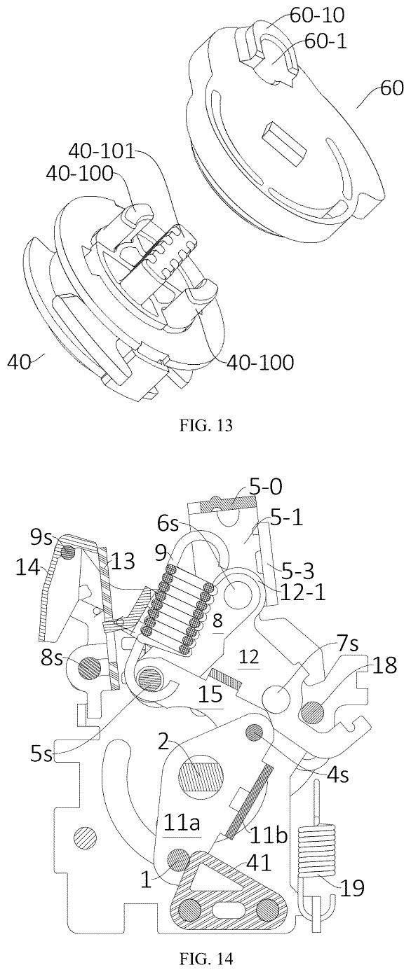

Further, as shown in FIGS. 12-13, the turntable 60 is connected with the adjacent contact support 40 in a transmission manner through a plug-in structure. Further, in the switch body, the adjacent contact supports 40 are connected in a transmission manner through the plug-in structure (not shown). The above structural design is conducive to simplifying assembly operations and improving the assembly efficiency. Specifically, the plug-in structure includes a plug and a jack, one of which is arranged on the contact support 40 and the other on the turntable 60. That is, one of the contact support 40 and the turntable 60 is provided with the plug, and the other is provided with the jack. In the present embodiment, the contact is preferably arranged on the contact support 40, and the jack is preferably arranged on the turntable 60. The plug includes a primary plug 40-101 and secondary plugs 40-100. The axis o-o passes through the middle of the primary plug 40-101. Two groups of secondary plugs 40-100 are arranged on both sides of the primary plug 40-101. The jack includes a primary jack 60-5 and secondary jacks 60-6, which cooperate with the primary plug 40-101 and the secondary plugs 40-100, respectively. Two groups of secondary jacks 60-6 are arranged on both sides of the primary jack 60-5. Further, a cross-section of the primary plug 40-101 is of a long strip structure, and a cross-section of each secondary plug 40-100 is of a fan-shaped structure. Two groups of secondary plugs 40-100 are symmetrically arranged on both sides of the primary contact 40-101. Further, a circle center of the two groups of secondary plugs 40-100 is on the axis o-o.

Further, as shown in FIG. 10, and 12-13, the turntable 60 includes a turntable connecting hole 60-1, and the turntable connecting hole 60-1 is located on a side of a rotation center of the turntable 60. That is, the turntable connecting hole 60-1 is located on a side of the axis o-o, and the transmission rod 1 is rotatably inserted into the turntable connecting hole 60-1. When the rotating shaft 11 rotates reciprocatingly, the transmission rod 1 cooperates with the turntable connecting hole 60-1 to drive the turntable 60 to rotate about the axis o-o.

Further, as shown in FIG. 13, the turntable 60 also includes a reinforced enclosure 60-10. The reinforced enclosure 60-10 is arranged outside one end of the turntable connecting hole 60-1 facing the mechanism bracket 0. The reinforced enclosure 60-10 is conducive to enhancing the structural strength of the turntable connecting hole 60-1 and prolonging the service life of the turntable 60.

Further, as shown in FIG. 12, the turntable 60 also includes a turntable main plate 60-3 and a turntable pillow block 60-2. The turntable connecting hole 60-1 is formed in the turntable main plate 60-3. The turntable pillow block 60-2 is arranged on a side of the turntable main plate 60-3 away from the mechanism bracket s. That is, the turntable pillow block 60-2 is arranged on a side of the turntable main plate 60-3 facing the switch body 200. The mechanism housing h of the operating mechanism 100 is provided with a turntable shaft hole. The turntable pillow block 60-2 is rotatably arranged in the turntable shaft hole.

Further, as shown in FIG. 12, an inlet of the jack of the turntable 60 is formed in the turntable pillow block 60-2. That is, the plug of the contact support 40 is inserted into the jack of the turntable 60 facing the turntable pillow block 60-2.

Further, as shown in FIG. 10 and FIG. 22, the operating mechanism further includes a mechanism housing h and a main body. The main body includes a mechanism bracket 0, a link structure, a driving shaft structure, a rotating shaft 11 and a transmission structure 34. The main body and the turntable 60 are both arranged in the mechanism housing h. The turntable 60 is located on a side of the main body along an axial direction. The turntable 60 includes a turntable connecting hole 60-1 and an anti-fool structure. One end of the transmission rod 1 is a plug-in end for plug-in fit with the turntable connecting hole 60-1. The anti-fool structure is used to abut against the plug-in end that is not inserted into the turntable connecting hole 60-1, preventing the main body from being installed in place. During assembly, the turntable 60 is first installed in the mechanism housing h before the main body, and the insertion end is not inserted into the turntable connecting hole 60-1. Then, the plug-in end abuts against the fool-proof structure, preventing the main body from being installed in place. In other words, the main body cannot be installed in the mechanism housing h in a correct posture. The anti-fool structure can prevent the main body from being installed in place in the mechanism housing h when the transmission rod 1 and the turntable 60 are not properly assembled, so as to avoid rework due to the improper assembly of the main body and the turntable 60, and improve the qualified rate and efficiency of product assembly.

Further, as shown in FIG. 22, the side of the turntable 60 facing the main body is a mating side; and the anti-fool structure is a shield surface arranged on the mating side. That is, in the process of installing the main body into the mechanism housing h, if the plug-in end of the transmission rod 1 is not inserted into the turntable connecting hole 60-1 of the turntable 60, the plug-in end will abut against the shield surface, so that the main body cannot be installed in place, thereby prompting the operator to have an incorrect installation.

Further, a maximum rotation angle of the turntable 60 is a stroke angle. On a projection of a rotating axis (i.e., the axis o-o) perpendicular to the turntable 60, the shield surface covers at least two arc-shaped areas. One end of each arc-shaped area is connected to the turntable connecting hole 60-1. The circle center of each arc-shaped area coincides with the rotation center of the turntable 60. A center angle of each arc-shaped area is half of the stroke angle. The two arc-shaped areas are symmetrically distributed by taking the circle center of the turntable connecting hole 60-1 and a center line of the rotation of the turntable 60 as symmetry axes.

Specifically, as shown in FIG. 5, the turntable 60 includes a turntable main plate 60m and a turntable extension plate. The turntable extension plate is arranged around a circumferential side of the turntable main plate 60m. A center angle of the turntable extension plate is less than 360°. That is, the turntable extension plate is an arc-shaped plate which is arranged around the circumferential side of the turntable main plate 60m. On a projection perpendicular to the rotating axis of the turntable 60, the outer edges of the two arc-shaped areas (i.e., the side edges of the arc-shaped areas away from the rotation center of the turntable 60) are located on the turntable extension plate, the inner edges of the arc-shaped areas (i.e., the side edges of the arc-shaped areas near the rotation center of the turntable 60) are located on the turntable extension plate (i.e., the arc-shaped areas are entirely located on the turntable extension plate) or on the turntable main plate 60m (i.e., the arc-shaped areas are arranged to span over the turntable main plate 60m and the turntable extension plate along a radial direction of the turntable 60), and one side of the turntable main plate 60m and one side of the turntable extension plate facing the main body are coplanar as a main plane 60-3p. The turntable 60 also includes a first boss and a second boss which are arranged on the main plane 60-3p. The first boss and the second boss are arranged to protrude along the axial direction of the turntable 60. The turntable connecting hole 60-1 is formed in the first boss. A table of the first boss is a first table 60-1p, and a table of the second boss is a second table 60-2p. The first boss 60-1p, the second table 60-2p and the main plane 60-3p are sequentially arranged in parallel along the axial direction of the turntable 60 and away from the main body successively. The first table 60-1p is flush with the inlet end of the turntable connecting hole 60-1. The above structural design not only ensures the structural strength of the outer sidewall of the turntable connecting hole 60-1, prolongs the service life of the turntable 60, plays a foolproof role, reduces the amount of materials, reduces the production cost, and improves the overall structural strength of the turntable 60. During assembly, the plug-in end of the transmission rod 1 is not inserted into the turntable connecting hole 60-1 of the turntable 60. Then, with the change of the relative position between the transmission rod 1 and the turntable 60, the plug-in end abuts against the first shield surface 60-1p or the second shield surface 60-2p or the third shield surface 60-3p.

As other embodiments, the shield surface covers at least an annular area having a width equal to the diameter of the turntable connecting hole 60-1. The turntable connecting hole 60-1 is located in the annular area on its axial projection. Therefore, no matter what the rotation angle of the turntable 60 is, the plug-in end of the transmission rod 1 will abut against the shield surface as long as it is not inserted into the turntable connecting hole 60-1. Of course, due to the limitations of the structural design of the operating mechanism, the turntable 60 can only be rotated within a certain angle. Further, the shield surface covers the entire area of the mating side except the turntable connecting hole 60-0, which is conducive to reducing the design difficulty of the turntable 60.

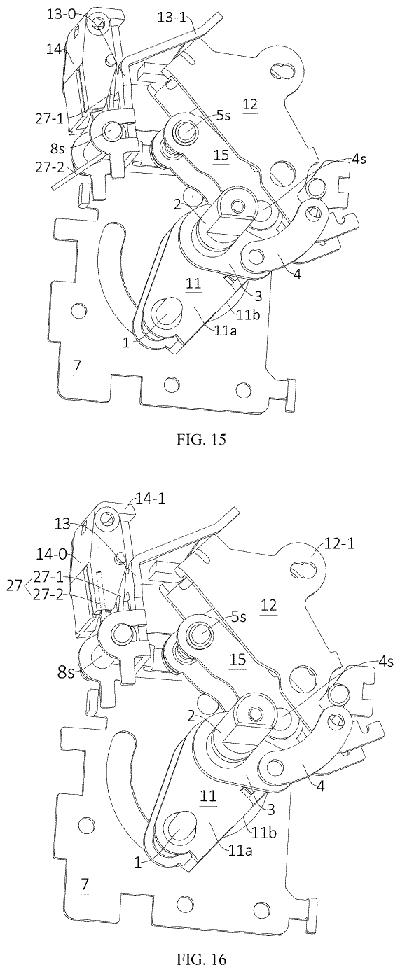

As shown in FIGS. 15-19, the link structure further includes a return spring 27 arranged between the lock buckle 13 and the re-buckle 14. The re-buckle 14 includes a vertical arm 14-0 and a transverse arm 14-1 which are connected in a bending manner. Two spring arms of the return spring 27 cooperate with the lock buckle 13 and the vertical arm 4-0, respectively. When the operating mechanism is in normally opened and closed states, the lock buckle 13 keeps snap fit with the jump buckle 12 and keeps first limiting fit with the transverse arm 14-1. The re-buckle 14 is driven by an external force to rotate. The transverse arm 14-1 releases first limiting fit from the lock buckle 13. The lock buckle 13 and the jump buckle 12 rotate respectively to release snap fit. The operating mechanism trips, and the lock buckle 13 establishes second limiting fit with the transverse arm 14-1. The transverse arm 14-0 includes a spring limiting groove 14-01 formed in a side facing the lock buckle 13, and an avoidance notch 14-00 formed in a side of the spring limiting groove 14-01. A spring arm (hereinafter referred to as the second arm 27-2) of the return spring 27 cooperating with the vertical arm 14-0 is toggled and enters the spring limiting groove 14-01 through the avoidance notch 14-00. Specifically, during assembly, the return spring 27 is first arranged to sleeve a spring shaft, and a spring arm (hereinafter referred to as the first arm 27-1) of the return spring 27 cooperating with the lock buckle 13 is placed between the re-buckle 14 and the lock buckle 13; then, the second arm 27-2 is toggled by an external force, and swings from a side of the vertical arm 14-0 (a side away from the lock buckle 13) through the avoidance notch 14-00 to the other side of the vertical arm 14-0 (a side facing the lock buckle 13); then, the second arm 27-2 is placed in the spring limiting groove 14-01 to complete the assembly of the return spring 27; and the first arm 27-1 always abuts against the lock buckle 13 while the second arm 27-2 is toggled. When the existing operating mechanism is assembled, one of the two spring arms of the return spring is close to a lock buckle main body of the lock buckle, and the other abuts against the spring limiting groove of the re-buckle. Then, the re-buckle is assembled on the bracket by an external force against the elastic force of the return spring. The return spring is installed into the bracket in an energy storage state, which is prone to the inclination of the re-buckle and the lock buckle, and needs to be corrected after assembly, thereby affecting the assembly efficiency. When the operating mechanism of the present invention is assembled, the structural design of the avoidance notch 14-00 of the re-buckle 14 and the spring limiting groove 14-01 enables the operating mechanism to first complete the assembly of the lock buckle 13, the re-buckle 14, the return spring 27 and the spring shaft, and the mechanism support 0 in the assembly process. After the upper side plate 6 and the lower side plate 7 of the mechanism support 0 are fixed to each other (for example, the upper side plate 6 and the lower side plate 7 are fixedly connected together by a connecting shaft), the assembly between the return spring 27 and the re-buckle 14 is completed, thereby simplifying the assembly operation, reducing the assembly difficulty of the return spring 27, and improving the assembly efficiency.

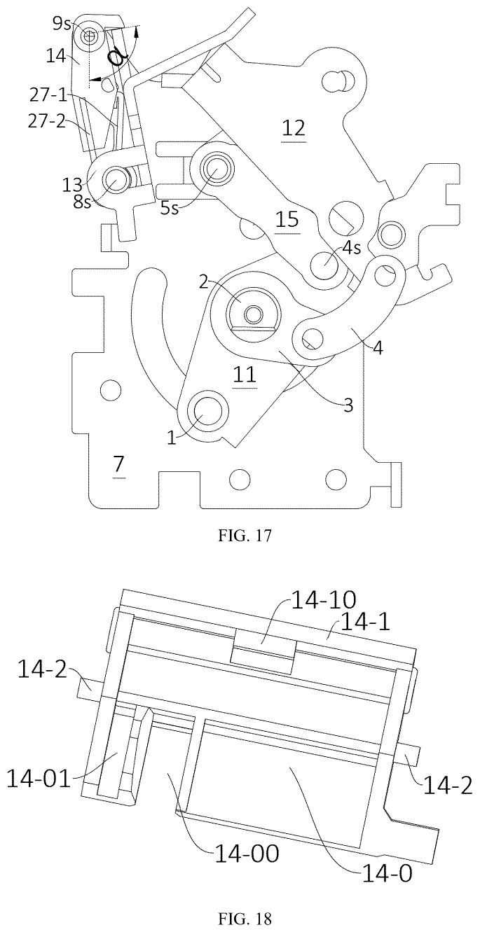

As shown in FIGS. 16 and 17, the return spring 27 makes the lock buckle 13 and the re-buckle 14 have a tendency to rotate in the same direction. Specifically, in a direction as shown in FIGS. 16 and 17, the return spring 27 makes the lock buckle 13 and the re-buckle 14 have a tendency to rotate in a clockwise direction. Further, both ends of the lock buckle main body 13-0 of the lock buckle 13 are a lock buckle pivoting end and a lock buckle mating end, respectively. The lock buckle main body 13-0 is rotatably arranged on the mechanism bracket 0 through the lock buckle pivoting end. The transverse arm 14-1 of the re-buckle 14 is opposite to the lock buckle mating end, and a free end of the vertical arm 14-0 (i.e., one end of the vertical arm 14-0 away from the transverse arm 14-1) is opposite to the lock buckle pivoting end. One of the two spring arms of the return spring 27 cooperates with the lock buckle mating end, and the other cooperates with the free end of the vertical arm 14-1, such that the lock buckle 13 and the re-buckle 14 have a tendency to rotate in the same direction.

As shown in FIGS. 15-17, the lock buckle 13 is rotatably arranged on the mechanism bracket 0 through an eighth shaft 8s. The eighth shaft 8s is used as a spring shaft, which is conducive to reducing the number of parts of the operating mechanism.

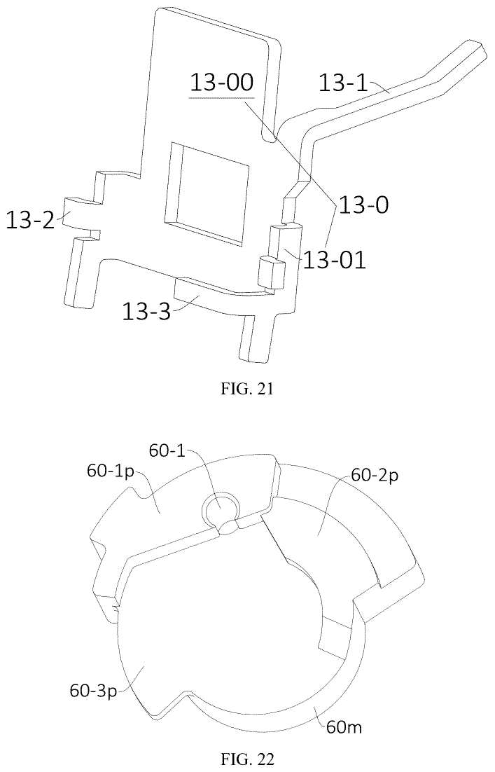

As other embodiments, as shown in FIGS. 20-21, the return spring 27 is a torsion spring. The lock buckle 13 includes a spring supporting arm 13-3 arranged on the lock buckle main body 13-0. The return spring 27 is arranged to sleeve the spring supporting arm 13-3. One spring arm cooperates with the lock buckle 13, and the other spring arm cooperates with the re-buckle 14. Further, the lock buckle 13 also includes lock buckle supporting fingers 13-2. Two lock buckle supporting fingers 13-2 are arranged on both ends of the lock buckle main body 13-O close to the upper side plate 6 and the lower side plate 7 of the mechanism bracket 0. The two lock buckle supporting fingers 13-2 are rotatably arranged on the upper side plate 6 and the lower side plate 7, respectively. The upper side plate 6 and the lower side plate 7 are preferably provided with a lock buckle rotating shaft hole, respectively. The two lock buckle supporting fingers 13-2 are rotatably inserted into the two lock buckle rotating shaft holes, respectively. Further, the lock buckle main body 13-0 includes a lock buckle main plate 13-00 and lock buckle side plates 13-01. The two lock buckle side plates 13-01 are opposite each other, and are connected to both ends of the lock buckle main plate 13-00. The two lock buckle supporting fingers 13-2 are arranged on the two lock buckle side plates 13-01, respectively. One end of the spring supporting arm 13-3 is connected with one lock buckle side plate 13-01 in a bending manner and is opposite to the lock buckle main plate 13-00 side by side. One end of a lock buckle long arm 13-1 is connected with the lock buckle main plate 13-00 in a bending manner. As a variation of the above embodiments, the lock buckle 13 may also not be provided with lock buckle supporting fingers 13-2, but two lock buckle side plates 13-01 are rotatably arranged on the mechanism bracket 0 through the eighth shaft 8s. The eighth shaft 8s passes through the two lock buckle side plates 13-01, and both ends of the eighth shaft 8s are arranged on the upper side plate 6 and the lower side plate 7.

In addition, it should be pointed out that the return spring 27 is not limited to the torsion spring, which may be arranged on the mechanism bracket 0 or the lock buckle 13, as long as it has two spring arms that cooperate with the lock buckle 13 and the re-buckle 14 respectively and exert forces on the lock buckle 13 and the re-buckle 14 respectively, so that the lock buckle 13 and the re-buckle 14 have a tendency to rotate in the same direction. For example, the return spring 27 is a V-shaped spring plate, a bend of which is arranged on the mechanism bracket 0 or the lock buckle 13, and two spring arms of which cooperate with the lock buckle 13 and the re-buckle 14 respectively.

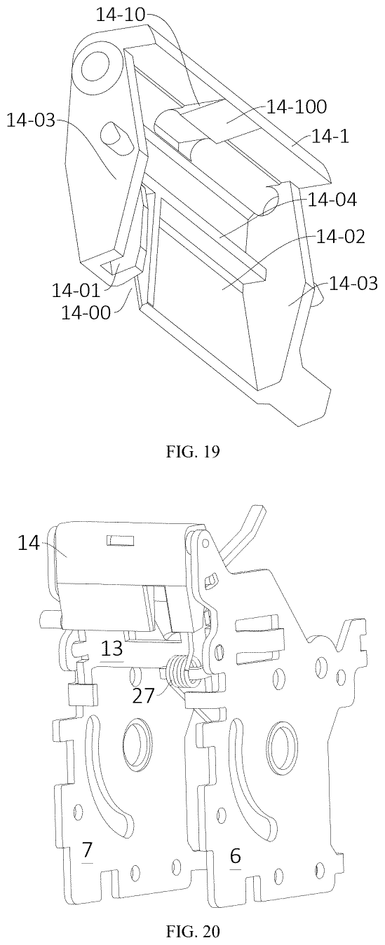

As shown in FIGS. 18-19, in the re-buckle 14, one end of the vertical arm 14-0 is connected with the transverse arm 14-1 in a bending manner, and the spring limiting groove 14-01 is formed in a side of the other end of the vertical arm 14-0 that faces the lock buckle 13. The bending connection between the vertical arm 14-0 and the transverse arm 14-1 is rotatably arranged on the bracket 13. Further, the vertical arm 14-0 includes a vertical arm main plate 14-02, vertical arm side plates 14-03 and a vertical arm stiffener 14-04. The two vertical arm side plates 14-03 are connected with the vertical arm main plate 14-02 side by side in a bending manner, respectively. The two vertical arm side plates 14-03 are preferably connected with both ends of the vertical arm main plate 14-02 in a bending manner, and the overall cross-section is in a LI-shaped structure. One end of the vertical arm main plate 14-02 and one ends of the vertical arm side plates 14-03 are connected to one side of the transverse arm 14-1, respectively. The vertical arm side plates 14-03 are preferably connected to both ends of the transverse arm 14-1 and are of a LI-shaped structure as a whole. The vertical arm stiffener 14-04 is arranged in the middle of the vertical arm main plate 14-02 and is located between the two vertical arm side plates 14-03. Both ends of the vertical arm stiffener 14-04 are connected to the two vertical arm side plates 14-03 and arranged side by side with the transverse arm 14-1. The spring limiting groove 14-01 is close to one of the vertical arm side plates 14-03. The spring limiting groove 14-01 and the transverse arm 14-1 are located on both sides of the vertical arm stiffener 14-04. The re-buckle 14 is of a frame-type structure as a whole, with a simple structure and high strength, and the overall weight is light, thereby saving production materials and cost.

As shown in FIGS. 17-18, the re-buckle 14 also includes a limiting surface 14-100 arranged on the transverse arm 14-1. The lock buckle 13 is rotatably arranged on the mechanism bracket 0 through the lock buckle main body 13-0. When the operating mechanism is in a tripped state, the limiting surface 14-100 abuts against one end of the lock buckle main body 14-0 to prevent the re-buckle 14 from resetting, that is, prevent the re-buckle 14 from rotating under the force of the return spring 27. The re-buckle 14 keeps a second limiting fit state with the lock buckle 13 and cannot be switched to a first limiting fit state. Further, the re-buckle 14 includes a limiting boss 14-10 arranged on the transverse arm 14-1, and a side of the limiting boss 14-10 facing the vertical arm 14-0 is the limiting surface 14-100. Further, when the operating mechanism is in a tripped state, the limiting surface 14-100 is in line or surface contact with one end of the lock buckle main body 13-0. Specifically, when the operating mechanism is in a tripped state, the limiting surface 14-100 is in line contact with the tip of the lock buckle mating end of the lock buckle main body 13-0.

As shown in FIG. 17, an included angle a between a center line of the vertical arm 14-0 of the re-buckle 14 and the limiting surface 14-100 is greater than 90°, so as to ensure that when the operating mechanism is re-buckled, the lock buckle 13 can be smoothly separated from the limiting surface 14-100 and reset, thereby avoiding the failure of the operating mechanism caused by dead buckling of the re-buckle 14 and the lock buckle 13.

As shown in FIG. 19, one end of each vertical arm side plate 14-03 of the re-buckle 14, which is connected to the transverse arm 14-1, is provided with a re-buckle shaft hole for a ninth shaft 9s to pass through.

As shown in FIGS. 18-20, the re-buckle 14 also includes a stroke limiting shaft 14-2 arranged on the vertical arm 14-0. The mechanism bracket 0 is provided with a stroke limiting hole. The stroke limiting shaft 14-2 is movably inserted into the stroke limiting hole to limit a rotation stroke of the re-buckle 14. Further, the re-buckle 14 includes two stroke limiting shafts 14-2 which are arranged on both sides of the vertical arm 14-0 (specifically, the two stroke limiting shafts 14-2 are respectively arranged on the two vertical arm side plates 14-02 of the vertical arm 14-0). The upper side plate 6 and the lower side plate 7 of the mechanism bracket 0 are provided with a stroke limiting hole, respectively. The two stroke limiting shafts 14-2 are movably inserted into the two stroke limiting holes, respectively.

As shown in FIGS. 15-17, after the operating mechanism is tripped, the lock buckle 13 and the jump buckle 12 abut against each other to prevent the lock buckle 13 from resetting, thereby avoiding dead buckling when the lock buckle 13 resumes snap fit with the jump buckle 12. In addition, in the whole process of the rocker arm 5 driving the jump buckle 12 to rotate to resume snap fit with the lock buckle 13, the jump buckle 12 always abuts against the lock buckle 13 until the jump buckle 12 resumes snap fit with the lock buckle 13. Specifically, as shown in FIGS. 15-17, and 21, the lock buckle 13 includes a lock buckle long arm 13-1. When the operating mechanism is in a tripped state, the jump buckle 12 and the lock buckle long arm 13-1 abut against each other to prevent the lock buckle 13 from resetting. That is, the lock buckle 13 is kept stationary under the combined action of the return spring 27 and the jump buckle 12. Further, one end of the lock buckle long arm 13-1 is connected to the lock buckle main body 13-1 of the lock buckle 13, and the other end of the lock buckle long arm 13-1 cooperates with the jump buckle 12.

As shown in FIG. 11 and FIG. 14, the operating mechanism further includes a buffer part 41. When the operating mechanism is opened, the output structure hits and docks on the buffer part 41. The output structure includes a rotating shaft 11 and a transmission rod 1. That is, when the operating mechanism is opened, the output structure hits the buffer part 41 to stop the output structure from rotating (that is, to stop the rotating shaft 11 from rotating). The output structure finally abuts against the buffer part 41 and stays in a disconnected position. At this time, the output structure also drives the moving contact mechanism to stay in its disconnected position. The buffer part 41 is made of a flexible material, such as plastic or rubber, and plays a buffering role in the operating mechanism to ensure that the operating mechanism will not trip and disintegrate due to hard impact during the opening process. Further, the transmission rod 1 of the output structure hits and docks on the buffer part 41 when the operating mechanism is opened. Further, the buffer part 41 is fixed on the mechanism bracket 0 by means of a buffer part assembling portion. A buffer portion of the buffer part is arranged on the buffer part assembling portion. The buffer portion of the buffer part is of a V-shaped plate structure. Both ends of the buffer portion are connected to the buffer part assembling portion, and the tip of the buffer portion faces the rotating shaft 11. Of course, the buffer portion of the buffer part may also be of other shapes of structures, such as an arc-shaped plate, a wavy plate or a single-layer plate, or in many other forms, which will not be listed here.

As other embodiments, when the operating mechanism is opened, the rotating shaft 11 of the output structure hits and docks on the buffer part 41.

As shown in FIG. 11 and FIG. 14, the rotating shaft 11 includes rotating shaft side plates 11a and a rotating shaft connecting plate 11b. Two rotating shaft side plates 11a are spaced apart from each other and connected with the rotating shaft connecting plate 11b in a bending manner, respectively. The middle of each of the two rotating shaft side plates 11a rotates about the axis o-o. Both ends of each of the two rotating shaft side plates 11a are connected with the link structure and the transmission rod 1 in a transmission manner. Further, the two rotating shaft side plates 11a are rotatably arranged on the mechanism bracket 0. One end of each rotating shaft side plate 11a is rotatably connected to the second link 15 through a fourth shaft 4s, and the other end of the rotating shaft side plate 11a is connected with the moving contact mechanism in a transmission manner (this end is connected to the transmission rod 1, and the transmission rod 1 drives the turntable 60 to rotate and the turntable 60 drives the moving contact mechanism to rotate). Further, each of the two rotating shaft side plates 11a is provided with a rotating shaft hole. The two rotating shaft side plates 11a are arranged to sleeve the driving shaft 2 of the driving shaft structure through the rotating shaft holes and are thus rotatably installed on the mechanism bracket 0.

As shown in FIG. 11 and FIG. 14, the operating mechanism further includes an auxiliary spring 19 acting on the jump buckle 12. After the lock buckle 13 releases snap fit from the jump buckle 12, the main spring 9 and the auxiliary spring 19 are used to drive the jump buckle 12 to rotate in the same direction. That is, both the main spring 9 and the auxiliary spring 19 exert forces on the jump buckle 12. Both forces cause the jump buckle 12 to rotate in the same direction. The jump buckle 12 rotates away from the lock buckle 13, and after rotating to a tripping position along a tripping direction, is in limiting fit with the rocker arm 5, so that the jump buckle 12 and the rocker arm 5 remain relatively stationary. Due to the cooperation of the main spring 9 and the auxiliary spring 19, the disintegration speed and tripping speed of the operating mechanism can be improved significantly, and the action time of the operating mechanism can be shortened. In addition, both the main spring 9 and the auxiliary spring 19 can drive the moving contact mechanism to rotate towards a disconnected position through the jump buckle 12, the second link 15, the first link 8 and the rotating shaft 11, which facilitates improving the breaking efficiency of the moving contact mechanism and the static contact, and improving the breaking ability of the isolating switch.

Further, the middle of the jump buckle 15 is rotatably arranged on the mechanism bracket 0. One end of the jump buckle 15 is in snap fit with the lock buckle 13, and the other end of the jump buckle 15 is connected to the auxiliary spring 19, Further, one end of the auxiliary spring 19 is connected to the jump buckle 12, and the other end of the auxiliary spring 19 is fixedly arranged on the mechanism bracket 0. Further, the mechanism bracket 0 is provided with a bracket hanging spring portion. The jump buckle 12 is provided with a jump buckle hanging spring portion. Both ends of the auxiliary spring 19 are connected to the bracket hanging spring portion and the jump buckle hanging spring portion. Further, the bracket hanging spring portion and/or the jump buckle hanging spring portion are/is hook(s) or hanging hole(s).

As shown in FIG. 14, the operating mechanism is not provided with a reset shaft 17. The rocker arm 5 also includes a reset portion 5-3. The reset portion 5-3 is arranged on the rocker arm leg 5-1. The jump buckle 12 includes a reset protrusion 12-1. After the operating mechanism is tripped, the rocker arm 5 is in the tripping position. When the rocker arm 5 swings to the opening position, the jump buckle 12 resets to resume snap fit with the lock buckle 13 synchronously by abutting the reset portion 5-3 against the reset protrusion 12-1. Further, the reset portion 5-3 is a reset plate which is connected with the rocker arm leg 5-1 in a bending manner. The reset protrusion 12-1 includes the reset protrusion arc-shaped surface. The reset plate abuts against the reset protrusion arc-shaped surface, so that the jump buckle 12 resets to resume snap fit with the lock buckle 13. Further, the jump buckle 12 is rotatably connected to the first link 8 through the reset protrusion 12-1.

As shown in FIG. 14, the operating mechanism is not provided with a separate stopper 16, and the fifth shaft 5s of the operating mechanism is used as the stopper 16.

FIG. 14 shows a layout mode of the operating mechanism of the rotary isolating switch of the present embodiment: an installation space is formed between the two side plates of the mechanism bracket 0; the jump buckle 12, the main spring 9, the second link 15, the first link 8, the lock buckle 13, the re-buckle 14, the rotating shaft 11 and the auxiliary spring 19 are all located in the installation space; in a first direction of the installation space, both ends of the installation space are a first end and a second end, the rocker arm beam 5-0 of the rocker arm 5 is located outside the first end of the installation space, and the rotating shaft 11 is located in the second end of the installation space; in a second direction of the installation space, both ends of the installation space are a third end and a fourth end, the lock buckle 13 and the re-buckle 14 are located in the third end of the installation space, the auxiliary spring 19 is located in the fourth end of the installation space, and the jump buckle 12 extends from the third end to the fourth end; and the first direction and the second direction are parallel to the two side plates of the mechanism bracket 0, and the first direction intersects with the second direction. Further, in the second direction of the installation space, the buffer part 41 is arranged in the fourth end, and the rotating shaft 11 is located between the buffer part 41 and the rocker arm beam 5-0 of the rocker arm 5. The jump buckle stop shaft is arranged in the fourth end. The jump buckle stop shaft and the auxiliary spring 19 are located on both sides of the jump buckle 12 in the first direction of the installation space. The layout of the operating mechanism is reasonable and compact, which is conducive to reducing the space. Specifically, the first direction is a left-right direction in FIG. 14, and the second direction is a vertical direction in FIG. 14.

It should be explained that, in the description of the present invention, the terms such as “up”, “down”, “left”, “right”, “inner” and “outer” indicating the directional or positional relations on the basis of the directional or positional relations shown in the drawings are only used for conveniently describing the present invention and simplifying the description, not indicate or imply that the referred devices or elements must have a specific orientation and be configured and operated in a specific direction; therefore, they cannot be construed as a limitation on the present invention.

We have made further detailed description of the present invention mentioned above in combination with specific preferred embodiments, but it is not deemed that the specific embodiments of the present invention are only limited to these descriptions. A person skilled in the art can also, without departing from the concept of the present invention, make several simple deductions or substitutions, which all be deemed to fall within the protection scope of the present invention.

1. An operating mechanism, comprising a mechanism bracket, a link structure, a driving shaft structure and a rotating shaft which are rotatably arranged on the mechanism bracket, and a transmission structure, wherein the driving shaft structure is connected with the link structure in a transmission manner through the transmission structure; the link structure is connected with the rotating shaft in a transmission manner and drives the rotating shaft to rotate reciprocatingly; the rotating shaft is connected with a support shaft for carrying a moving contact in a transmission manner and drives the support shaft to rotate reciprocatingly; the link structure comprises a snap-fit structure; the snap-fit structure has a snap-fit state and a tripped state; the operating mechanism further comprises a transmission rod; the rotating shaft and the support shaft are both rotatably arranged about an axis o-o; both ends of the transmission rod are connected to the rotating shaft and the support shaft; and the transmission rod is located on a side of the axis o-o and parallel to the axis o-o.

2. The operating mechanism according to claim 1, wherein the mechanism bracket is provided with a transmission rod guide structure, and the transmission rod cooperates with the transmission rod guide structure to limit a swing trajectory of the transmission rod about the axis o-o.

3. The operating mechanism according to claim 2, wherein the mechanism bracket comprises an upper side plate and a lower side plate which are spaced apart from each other; the rotating shaft is rotatably arranged between the upper side plate and the lower side plate; the transmission rod guide structure comprises an upper guide structure arranged on the upper side plate and a lower guide structure arranged on the lower side plate; one end of the transmission rod passes through the rotating shaft and then cooperates with the upper guide structure, the other end of the transmission rod passes through the lower side plate and is then connected to the support shaft, and the transmission rod cooperates with the lower guide structure; and
the transmission rod comprises a transmission rod upper section, a transmission rod intermediate section and a transmission rod lower section which are sequentially connected in an axial direction; an outer diameter of the transmission rod intermediate section is greater than an outer diameter of the transmission rod upper section and an outer diameter of the transmission rod lower section; the transmission rod upper section is inserted into the rotating shaft, passes through the rotating shaft and then cooperates with the upper guide structure; the transmission rod intermediate section is located between the rotating shaft and the lower side plate, and is in limiting fit with the rotating shaft and the lower side plate to prevent the transmission rod from moving along the axial direction; and the transmission rod lower section passes through the lower side plate and is then connected to the support shaft.

4. The operating mechanism according to claim 1, wherein the operating mechanism further comprises a turntable which is fixedly connected to the support shaft and arranged between the transmission rod and the support shaft, and the rotating shaft is connected with the turntable in a transmission manner through the transmission rod to drive the support shaft to rotate; and the turntable is rotatably arranged about the axis o-o.

5. The operating mechanism according to claim 4, wherein the operating mechanism also comprises a mechanism housing (h) and a main body; the main body comprises a mechanism bracket, a link structure, a driving shaft structure, a rotating shaft and a transmission structure; the turntable is located on a side of the main body in an axial direction; the turntable comprises a turntable connecting hole and an anti-fool structure; one end of the transmission rod is a plug-in end for plug-in fit with the turntable connecting hole and the anti-fool structure is used to abut against the plug-in end that is not inserted into the turntable connecting hole preventing the main body from being installed in place.

6. The operating mechanism according to claim 1, wherein the operating mechanism further comprises a buffer part; and when the operating mechanism is opened, an output structure hits and docks on the buffer part, and the output structure comprises a rotating shaft and a transmission rod.

7. The operating mechanism according to claim 1, wherein the driving shaft structure comprises a driving shaft which is rotatably arranged on the mechanism bracket;
the link structure also comprises a rocker arm, wherein the rocker arm is rotatably arranged on the mechanism bracket, and the rocker arm is driven by an external force to swing reciprocatingly, so that the operating mechanism is closed and opened;
the transmission structure comprises a crank and a transmission link, wherein the crank is arranged on the driving shaft and rotates synchronously with the driving shaft, and the transmission link is connected with the crank and the rocker arm in a transmission manner;
the driving shaft is rotatably inserted into the rotating shaft about the axis o-o;
the rocker arm comprises a rocker arm beam, rocker arm legs and connecting toes, wherein two rocker arm legs are arranged to face each other and rotatably arranged on the mechanism bracket respectively, and one end of each of the two rocker arm legs is connected with the rocker arm beam in a bending manner;
the rocker arm beam and the connecting toes are located on both sides of a rotating axis of the rocker arm; and
the mechanism bracket comprises an upper side plate and a lower side plate which are spaced apart from each other; two rocker arm legs are located on both sides of the upper side plate and the lower side plate and rotatably arranged on the upper side plate and the lower side plate, respectively; each of the two rocker arm legs is provided with the connecting toe; and two groups of transmission structures are arranged on both sides of the upper side plate and the lower side plate;
and the driving shaft is connected to the two connecting toes through the two groups of transmission structures.

8. The operating mechanism according to claim 1, wherein the rotating shaft comprises a rotating shaft main body a rotating shaft connecting arm and a rotating shaft driving arm; the rotating shaft is rotatably arranged on the mechanism bracket through the rotating shaft main body the rotating shaft connecting arm and the rotating shaft driving arm are arranged on both radial sides of the rotating shaft main body, and connected to the link structure and the transmission rod; or
the rotating shaft comprises rotating shaft side plates and a rotating shaft connecting plate, wherein two rotating shaft side plates are spaced apart from each other and connected with the rotating shaft connecting plate in a bending manner, respectively; the middle of each of the two rotating shaft side plates rotates about the axis o-o; and both ends of each of the two rotating shaft side plates are connected with the link structure and the transmission rod in a transmission manner.

9. The operating mechanism according to claim 1, wherein the link structure comprises a re-buckle, a jump buckle, and a lock buckle which are rotatably arranged on the mechanism bracket respectively, and a return spring arranged between the lock buckle and the re-buckle; the jump buckle keeps snap fit with the lock buckle through the snap-fit structure; the re-buckle comprises a vertical arm and a transverse arm which are connected in a bending manner, and two spring arms of the return spring cooperate with the lock buckle and the vertical arm respectively; when the operating mechanism is normally opened and closed, the lock buckle keeps snap fit with the jump buckle and keeps first limiting fit with the transverse arm the re-buckle is driven by an external force to rotate, the transverse arm releases first limiting fit from the lock buckle, the lock buckle and the jump buckle rotate respectively to release the snap fit, the operating mechanism is tripped, and the lock buckle establishes second limiting fit with the transverse arm- the vertical arm comprises a spring limiting groove arranged on a side thereof facing the lock buckle and an avoidance notch arranged on a side of the spring limiting groove and the spring arm of the return spring that cooperates with the vertical arm is toggled and enters the spring limiting groove through the avoidance notch

10. The operating mechanism according to claim 9, wherein one end of the vertical arm is connected with the transverse arm in a bending manner, and the spring limiting groove is formed in a side of the other end of the vertical arm that faces the lock buckle; and the bending connection between the vertical arm and the transverse arm is rotatably arranged on the mechanism bracket; and
the return spring makes the lock buckle and the re-buckle have a tendency to rotate in the same direction.

11. The operating mechanism according to claim 9, wherein the return spring is a torsion spring, which is arranged on the mechanism bracket or the lock buckle; and
the lock buckle comprises a lock buckle main body and a lock buckle supporting arm arranged on the lock buckle main body, wherein the lock buckle main body is in snap fit with the jump buckle; the return spring is sleeved over the lock buckle supporting arm with one spring arm cooperates with the lock buckle main body, and the other spring arm cooperates with the re-buckle.

12. The operating mechanism according to claim 9, wherein the re-buckle also comprises a limiting surface arranged on the transverse arm the lock buckle comprises a lock buckle main body the lock buckle is rotatably arranged on the mechanism bracket through the lock buckle main body;
and when the operating mechanism is in a tripped state, the limiting surface abuts against one end of the lock buckle main body to prevent the re-buckle from resetting;
one end of the lock buckle main body is a lock buckle pivoting end and the other end of the lock buckle main body is a lock buckle mating end, and the lock buckle main body is rotatably arranged on the mechanism bracket through the lock buckle pivoting end; the lock buckle pivoting end is opposite to a free end of the vertical arm, the lock buckle mating end is opposite to the transverse arm- and the limiting surface is arranged on a side of the transverse arm facing the vertical arm; when the re-buckle establishes first limiting fit with the lock buckle, the transverse arm abuts against a side of the lock buckle mating end facing the re-buckle; when the re-buckle establishes second limiting fit with the lock buckle, the limiting surface abuts against the tip of the locking buckle mating end;
when the operating mechanism is in a tripped state, the limiting surface is in line or surface contact with one end of the lock buckle main body; and
an included angle between the center line of the vertical arm and the limiting surface is greater than 90°.

13. The operating mechanism according to claim 9, wherein when the operating mechanism is in a tripped state, the jump buckle abuts against the lock buckle to prevent the lock buckle from resetting.

14. The operating mechanism according to claim 9, wherein the link structure also comprises a rocker arm, a first link, a spring and a second link, the rocker arm is rotatably arranged on the mechanism bracket; the first link is rotatably connected to the jump buckle; the second link is rotatably connected to the first link and the rotating shaft; one end of the spring is connected to the rocker arm, and the other end of the spring is connected to the rotatable connection between the first link and the second link; the rocker arm is also used to drive the jump buckle to resume snap fit with the lock buckle; a stopper is arranged on the first link and used to be in limiting fit with the jump buckle to prevent the first link from continuing to rotate when the operating mechanism is opened or tripped; and
the mechanism bracket comprises an upper side plate and a lower side plate which are spaced apart from each other; the first link, the spring, the jump buckle, the lock buckle and the second link are all arranged between the upper side plate and the lower side plate; and a plane where the jump buckle, the lock buckle, the first link and the second link rotate is parallel to the upper side plate and the lower side plate and perpendicular to the rotating shaft.

15. A rotary isolating switch, comprising the operating mechanism according to claim 1.
